(19) United States
(12) Patent Application Publication
(10) Pub. No.: US 2003/0185653 A1
(43) Pub. Date: Oct. 2, 2003

(54) Quick connect fastener with adjustable receptacle

(75) Inventors: Terrence S. Csik, Pasadena, CA (US); Ronald A. Duenas, Lake Forest, CA (US); Richard G. Paul, Upland, CA (US); Clif K. Tanaka, Harbor City, CA (US)

Correspondence Address: Irving Keschner, Suite 1150, 21515 Hawthorne Boulevard, Torrance, CA, 90503, US

(73) Assignee: The Monadnock Company

(21) Appl. No.: 10/106,914

(22) Filed: Mar. 26, 2002

(51) Int. Cl. F16B 21/00

(52) U.S. Cl. 411/551

(57) ABSTRACT

A quick connect fastener wherein the receptacle is adjustable to allow different stud types to be used and wherein absolute clamp-up is provided through repeated cycling. A spring loaded lock plate that captivates the quarter turn cross-pin in the locked position against the adjacent cam surface is provided. The lock plate is positioned within the receptacle and indicates the correct locked position at absolute clamp-up when the lock plate snaps over the cross-pin. Two ramps on the lockplate provide a positive “feel” when installing or removing the stud and provide the detent/lock feature. The cam comprises two helixed ramps leading to flat surfaces or plateaus for the cross-pin to ride up and tighten against. The plateaus are adjacent to detent recesses on the lock plate which provide the locking capability.

### BACKGROUND OF THE INVENTION

1. Field of the Invention

A quick connect fastener assembly for holding panels together wherein the fastener receptacle length is adjustable in a manner whereby full clamp-up is provided through repeated cycling.

2. Description of the Prior Art

Quarter turn stud fastener assemblies, or quick connect fasteners, have long been commercially available. Such fasteners include a grommet, stud and a receptacle, the fastener holding two panels together. As noted in U.S. Pat. No. 5,795,122 to Bowers, the drawback to the conventional quarter turn fastener is the total thickness of the two panels for which the fastener is effective must lie within a limited range; if the total thickness lies outside the range, a longer or shorter stud must be used. Thus, for most work applications, a variety of stud sizes must be purchased and kept on hand. To eliminate this problem, the Bowers patent discloses an adjustable receptacle. In particular, the receptacle includes an internally threaded body and an externally threaded barrel, wherein the threads of the body and the barrel are in engagement with one another so that rotation of the barrel relative to the body moves the barrel axially with respect to the body. Cam and locking surfaces for the cross pin of the stud are defined in the barrel. As a result, the position of the barrel within the receptacle body can be adjusted so that a single length stud can be used, and yet total panel thickness can be varied over a wide range.

When the desired position of the barrel has been set, semicylindrical grooves of equal diameter are drilled parallel to the axes of the barrel and the cylindrical body in the outer circumference of the barrel and in the inner annular surface of the cylindrical body. With each complete revolution of the barrel relative to the cylindrical body, the drilled grooves are in alignment with one another and, when the desired position of the barrel is achieved, the grooves are aligned and a spring roll pin of appropriate diameter is inserted into the aligned grooves to lock the barrel in the desired position.

The barrel member includes a pair of diametrically opposed curved slots which curve back toward the end of the barrel member and which define locking surfaces for the stud cross pin. However, this curve back feature causes a gap between the panels, during clamp-up, preventing full clamp-up, an undesirable condition in many fastener applications.

### SUMMARY OF THE INVENTION

The present invention provides a quick connect fastener wherein the receptacle is adjustable to allow different single stud types to be used for panel members of variable thickness and wherein absolute clamp-up is provided with the use of a lock plate cam assembly configuration.

A spring loaded lock plate positioned within the receptacle housing captivates the quarter turn cross pin in the locked position against an adjacent surface on the cam assembly. The lock plate indicates the correct locked position at absolute clamp-up when the lock plate snaps over the cross pin. Two ramps on the lower surface of the lock plate provide a positive “feel” when installing or removing the stud and provide the detent/lock feature. A crimped endcap on the housing prevents corrosive material from entering the interior of the receptacle and a crimped collar on the housing prevents the threaded cam assembly from being accidentally ejected from the rear of the housing during the initial installation process or subsequent depth adjustment of the cam assembly. The cam assembly includes two helixed ramps leading to flat surfaces, or plateaus, for the cross pin to ride up and tighten against a vertically extending surface on the cam assembly. The plateaus are adjacent to detent recesses on the lock plate which provide the fastener locking feature.

The present invention thus provides a quarter turn stud assembly fastener which provides absolute clamp-ups, wherein a stud of a fixed length can be used with panel members having a range of thickness and wherein a spring loaded lock plate provides the locking feature.

### DESCRIPTION OF THE DRAWING

For a better understanding of the present invention as well as other objects and further features thereof, reference is made to the following description which is to be read in conjunction with the accompanying drawing wherein:

FIG. 1 is a front elevational view illustrating the receptacle of the present invention holding two panel members together;

FIG. 2 is a front elevational view illustrating the receptacle of the present invention holding two panel members together, the thickness of the panel members being less than the thickness of the panel members shown in FIG. 1;

FIG. 3 is a bottom view of the receptacles shown in FIGS. 1 and 2;

FIG. 4 is a top view of the receptacles shown in FIGS. 1 and 2;

FIG. 5 is a cross-sectional view of the receptacle shown in FIG. 1;

FIG. 6 is a cross-sectional view along line 6-6 of FIG. 5, FIG. 7 is a cross-sectional view along line 7-7 of FIG. 5;

FIG. 8 is a cross-sectional view along line 8-8 of FIG. 5;

FIG. 9 is a cross-sectional view showing the upper plate moving upwards when unlocking;

FIG. 10 is a cross-sectional view showing the upper plate moving upwards when locking; and

FIG. 11 is a cross-sectional view of the receptacle shown in FIG. 2.

### DESCRIPTION OF THE INVENTION

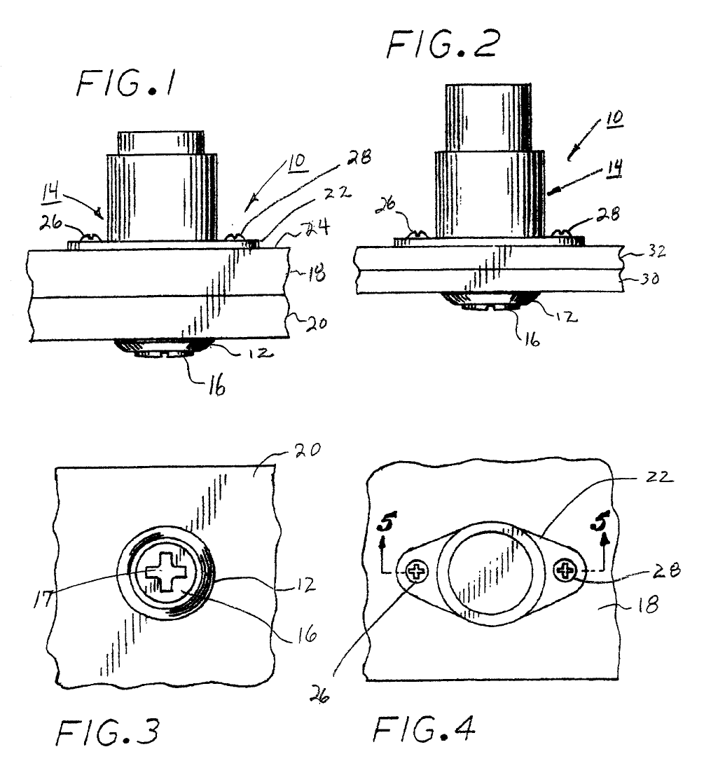

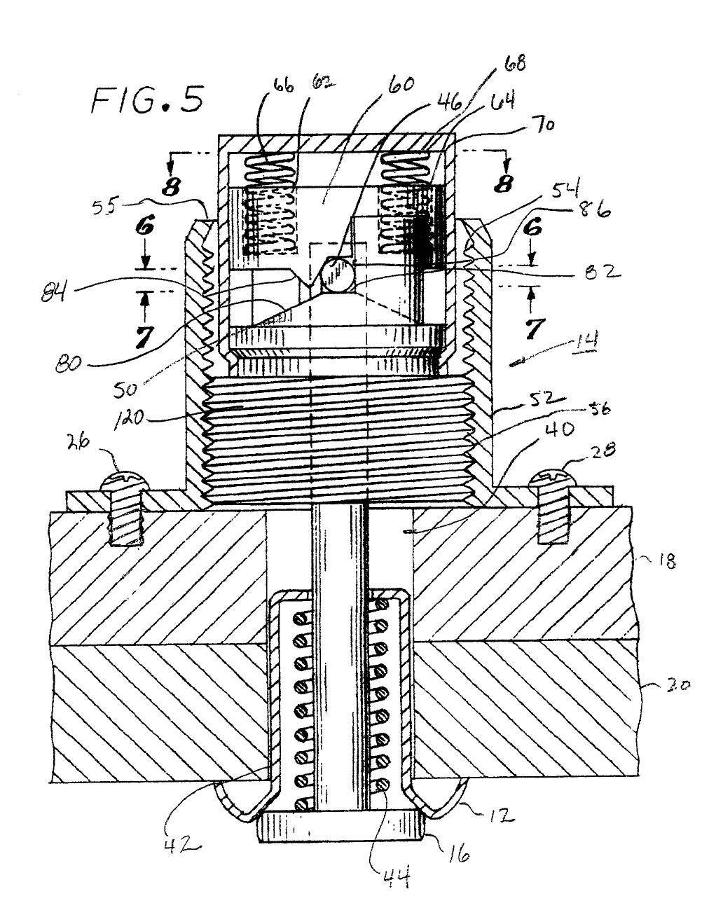

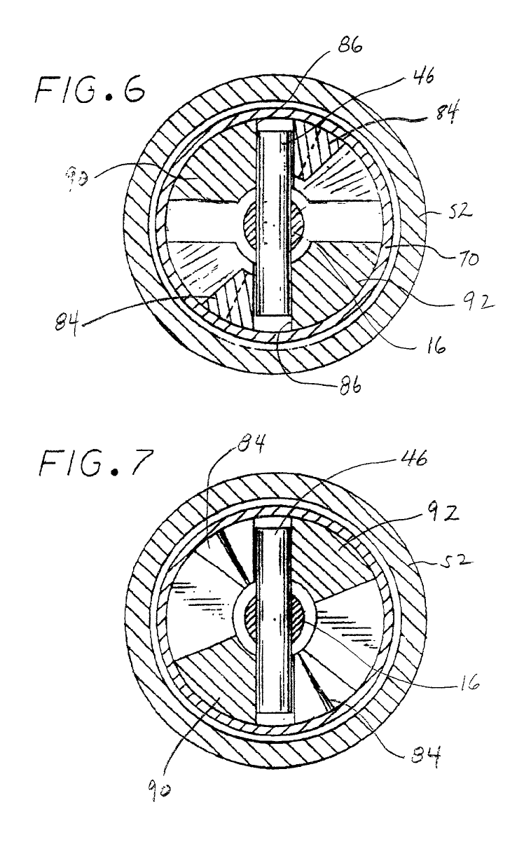

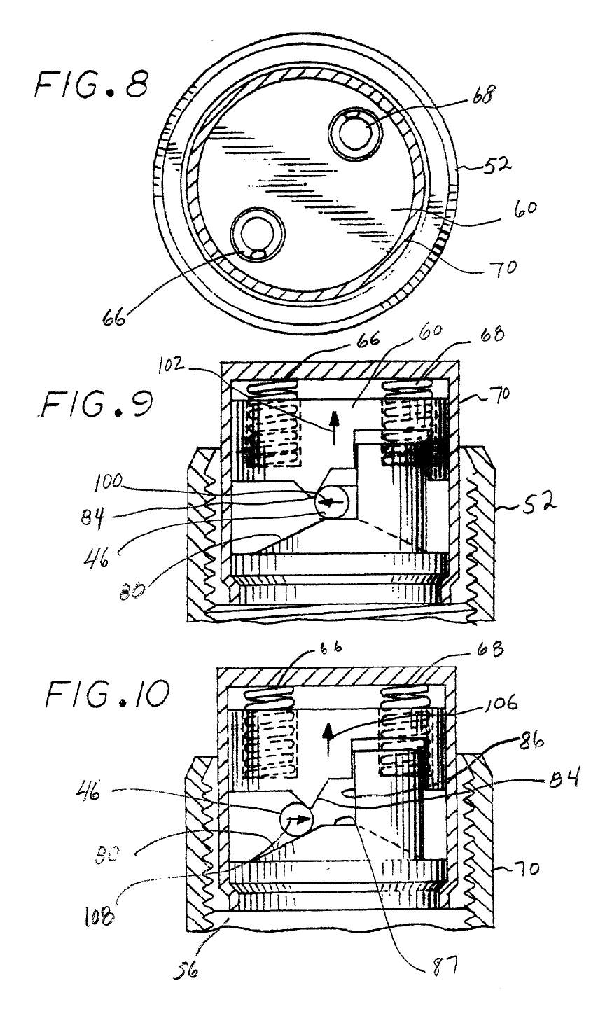

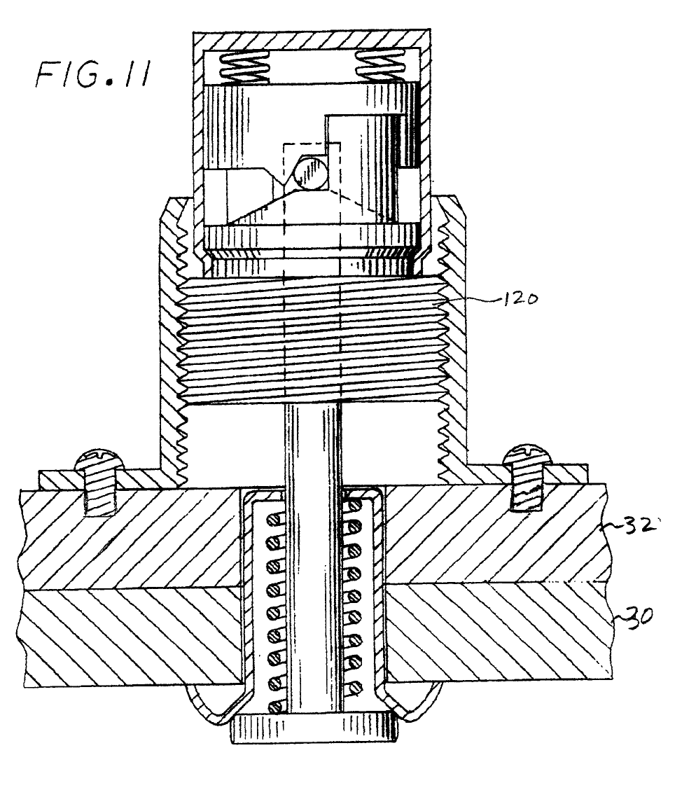

Referring now to FIGS. 1, 3 and 4, a front elevational, top and bottom views, respectively, of the novel quarter turn assembly, or quick connect fastener, 10 of the present invention is illustrated. The stud assembly comprises a grommet 12, a receptacle assembly 14, stud 16 and driving recess 17. The quarter turn assembly 10 is used to secure panel members 18 and 20, of a predetermined thickness, together. Flange portion 22 of receptacle assembly 14 is secured to the outside surface 24 of panel member 18 via metal fasteners 26 and 28 as illustrated.

FIG. 2 illustrates the quarter turn assembly 10 joining panel members 30 and 32 together, panel members 30 and 32 having a total thickness less than the thickness of panel members 18 and 20. In accordance with the teachings of the present invention, receptacle assembly 14 is adjustable to enable assembly 10 to accommodate panel members of varying thicknesses, grommet 12 and stud 16 being conventional items.

FIG. 5 is a cross-sectional view of the assembly 10 shown in FIG. 1. In particular, grommet 12 is positioned into coaligned apertures 40 and 42 formed in panel members 20 and 22, respectively. A coil spring 44 surrounds the portion of stud 16 within grommet 12, stud 16 extending into receptacle assembly 14 as illustrated. A locking cross pin 46 is positioned adjacent one end of stud 16 in a conventional manner. A cam assembly 50 is positioned within housing 52, housing 52 having a thread portion 54 formed along its internal diameter. The lower portion of cam assembly 50 has thread portion 56 formed on its outside diameter, threads 54 and 56 being in operative engagement as illustrated. A lock plate 60 having bores 62 and 64 located on its top surface, springs 66 and 68 being placed in bores 62 and 64, respectively, is positioned above cam assembly 50 within receptacle assembly 14. An endcap 70 is positioned over springs 66 and 68 and lockplate 60 to hold the components in place.

Due to the varying thickness of the panel members, cam assembly 50 within housing 52 is initially set within a 0.25 inch range. The first installation of the stud 16 (or with the use of a special tool), will rotate the cam assembly 50 within the receptacle housing, 52 thus creating an axial movement. An installation tool (not shown) inserted in driving recess 17 provides the absolute clamp-up condition, the cam assembly 50 thus being set for its correct depth for a particular stud length. The cam assembly 50 cannot move axially during repeated cycling after the initial set due to the resilient fixing on thread portion 56, the stud 16 thus always locating to the proper depth at full clamp up after repeated installations. In particular, in order to positively lock the cam assembly 50 with respect to the cylindrical receptacle housing 52, when the desired position of the cam assembly 50 has been set as noted hereinabove, a Resilient fixing material is interposed between the threads of the cam assembly 50 and the threads of the cylindrical housing 52. The resilient fixing material prevents movement of the cam assembly 50 relative to the housing 52 within the range of forces required to connect or disconnect the fastener. At a level of force beyond that required for connection and disconnection of the fastener, the resilient fixing material permits rotation of the cam assembly 50 and lock plate 60 while using a stud of fixed length. The resilient fixing material may be in the form of a nylon material surrounding the circumference of external thread portion 56 of cam assembly 50. Alternately, housing 52 can be crimped or deformed out-of-round to provide a positive lock against the axial movement of cam assembly 50.

The fastener 10 is locked as follows:

The stud cross pin 46 is passed through the aperture (bore) of cam assembly 50 and rotated until it passes through a matching rectangular cutout 53 (FIG. 6) therein. After cross pin 46 passes through the cutout 53, stud 16 continues to be rotated clockwise such that the cross pin 46 travels up ramp portion 80 adjacent plateau 82 on cam assembly 50, cross pin 46 striking helixed inverted ramps 84 formed on the bottom surface of the spring loaded lock plate 60. As stud 16 continues to rotate, cross pin 46 lifts lock plate 60 until cross pin 46 engages plateau 82. As stud 16 continues to rotate, cross pin 46 strikes the stop surface 86 of cam assembly 50, surface 86 being substantially perpendicular to plateau surface 82. Spring loaded lock plate 60, after being moved towards the top surface of end cap 70, returns to the extended position (away from endcap 70) providing the fastener locking feature. In particular, plateau surfaces 82 on cam assembly 50 provide the full clamp-up characteristic and the inverted ramps 84 on lock plate 60 provide the detent/lock characteristic of fastener 10.

The stud assembly 10 is unlocked as follows:

Stud cross pin 46 is rotated counterclockwise along the plateau surface 82 of cam assembly 50. The cross pin 46 then strikes the inverted ramps 84 on the adjacent spring loaded lock plate 60. As stud 16 continues to rotate, cross pin 46 lifts lock plate 60 until cross pin 46 passes under the inverted ramps 84 on lock plate 60 and travels down ramp 80 of cam assembly 50. Spring load lock plate 60 then returns to its extended position and stud 16 disengages from the receptacle assembly 14 as the cross pin 46 continues to rotate to, and passes through, the matching rectangular cutout 53 in cam assembly 50.

FIG. 6 is a cross-sectional view along line 6-6 of FIG. 5 and shows how cross pin (locking bar) 46 is locked, or secured within the receptacle assembly 14. Cam assembly 50 includes two vertically extending protrusions 90 and 92 surfaces 86 thereon acting as a stop for cross pin 46; lock plate 60, as noted hereinabove, has inverted helixed ramps 84 formed on its bottom surface.

FIG. 7 is a cross-sectional view along line 7-7 of FIG. 5 showing cross pin 46 from a different direction.

FIG. 8 is a cross-sectional view along line 8-8 of FIG. 5 showing the location of springs 66 and 68 within the bores formed in the top surface of lockplate 60.

FIG. 9 is a cross-sectional view of receptacle assembly 14 showing the locking plate 60 moving in the upwards direction when the quarter turn fastener assembly 10 is being unlocked. In this mode, as noted hereinabove, as stud 16 is rotated in the counter clockwise direction, cross pin 46 moves in the direction of arrow 100 and strikes inverted ramps 84, moving lock plate 60 in the direction of arrow 102. Cross pin 46 continues to move down ramp 80 past inverted ramps 84, enabling lock plate 60 to return to the position shown.

FIG. 10 is a cross-sectional view of receptacle 14 showing locking plate 60 moving in the direction of arrow 106 when the fastener assembly 10 is being locked. In this mode, as described hereinabove, as stud 16 is rotated in the clockwise direction, cross pin 46 moves in the direction of arrow 108, striking inverted ramps 84, moving lock plate 60 in the direction of arrow 106. Cross pin 46 continues to move up ramp 80 until it sits on plateau 82 and against stop surfaces 86. At this point, lock plate 60 moves in the direction opposite to arrow 106, returning to the extended position.

FIG. 11 is similar to FIG. 5 with the exception that the total panel thickness is less than the total thickness of panels 18 and 20. In this situation, receptacle assembly 14 is initially rotated within housing 52 such that threaded housing portion 56 is moved further away from panel member 32 as illustrated, enabling the same stud 16 utilized in the FIG. 5 embodiment to be used to secure panel members 30 and 32 together.

End cap 70 is preferably crimped to prevent corrosive material from entering the interior of the receptacle assembly. Housing 52 has a crimped collar 55 to prevent the threaded cam assembly 50 from being accidentally ejected from the rear of housing 52 during the initial installation process or subsequent depth adjustment of the cam assembly 50.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

What is claimed:

1. A fastener for securing together first and second panel members, each panel member having a aperture for receiving the fastener, a first side of said fastener engaging a surface of said first panel member, a second side of said fastener member engaging a surface of said second panel member, a grommet having an opening and an outward extending flange for engaging the second side of said second panel member, a stud having first and second ends, a head at said first stud end and a cross-pin adjacent said second stud end, said stud being received in the opening of said grommet, the improvement comprising:
an adjustable receptacle having an internally threaded housing and an externally threaded cam assembly, the thread of said housing and said cam assembly being in engagement, rotation of said cam assembly relative to said housing moving the cam assembly axially with respect to said housing, said cam assembly having a plurality of ramp surfaces, each ramp surface terminating at flat surfaces, said cross-pin riding on said ramp surfaces as said stud is rotated in a first direction, the movement of said cross-pin stopping when positioned on said flat surface.

2. The fastener of claim 1 further including a lock plate positioned adjacent said cam assembly within said housing.

3. The fastener of claim 2 wherein said lock plate has first and second surfaces, said first surface facing said cam assembly, a plurality of ramp members being formed on the first surface of said lock plate.

4. The fastener of claim 3 further including an end cap member for enclosing said housing.

5. The fastener of claim 4 wherein said second surface of said lock plate has a plurality of bores formed therein.

6. The fastener of claim 5 further including a plurality of spring members, each spring member having first and second ends, the first end of each spring member being positioned in corresponding bores.

7. The fastener of claim 1 further including a cutout formed in said cam assembly to enable said cross-pin to be positioned on said ramp surfaces.

8. The fastener of claim 6 wherein said panels are clamped up when said cross-pin is stopped on said flat surface.

9. The fastener of claim 8 wherein the ramps on said first surface of said lock plate lock said cross-pin on said flat surface.

10. The fastener of claim 8 wherein said cross-pin forces said lock plate towards said end cap from an initial position as said cross pin moves towards said flat surface.

11. The fastener of claim 10 wherein said lock plate returns to said initial position after said cross pin is positioned on said flat surface.
